(19) United States
(12) Patent Application Publication
(10) Pub. No.: US 2005/0223581 A1
(43) Pub. Date: Oct. 13, 2005

(54) Method of applying measuring markings

(76) Inventor: Kyle S. Hale, Krebs, OK (US)

Correspondence Address: Patterson, Thuente, Skaar & Christensen, P.A., 4800 IDS Center, 80 South 8th Street, Minneapolis, MN, 55402-2100, US

(21) Appl. No.: 11/151,490

(22) Filed: Jun. 13, 2005

Related U.S. Application Data
(63) Continuation of application No. 10/277,121, filed on Oct. 21, 2002.
(60) Provisional application No. 60/332,291, filed on Nov. 13, 2001.

(51) Int. Cl. G01B 3/10

(52) U.S. Cl. 33/758

(57) ABSTRACT

Siding having an integrated measuring system that can be concealed from sight upon completion of a project. The siding includes an exterior surface, a first distal end, a second distal end, and a first measuring initial printed on the exterior surface by a printing process during fabrication of the siding. The first indicia extends from the first distal end to the second distal end and divides the siding into measuring units. A user can measure and cut the siding material without using a separate measuring device.

### RELATED APPLICATIONS

This application is a continuation of application Ser. No. 10/277,121, filed Oct. 21, 2002, which claims the benefit of U.S. Provisional Application Ser. No. 60/332,291, filed 13 Nov. 2001, both of which are incorporated herein by reference.

### FIELD OF THE INVENTION

The present invention relates generally to construction materials and, more specifically, to construction materials having an integrated measurement system, marked upon various types of products that require a specified cut in length. For example, the material to be measured can be any extrusion or roll formed product to which a measuring device in accordance with the present invention is applied such as siding (aluminum, steel or vinyl), trim accessories used in conjunction with the siding, pipe lengths (plastic, PVC, steel or the like) or similar devices.

### DESCRIPTION OF THE PRIOR ART

Numerous types of measuring system have been provided in the prior art. For example, U.S. Pat. Nos. 2,245,133; 2,270,419; 2,449,265; 3,407,507; 4,149,320; 4,351,113; 4,858,402; 4,927,696; 5,632,095; 5,632,095; 5,673,489; 5,924,213 and 6,269,595 are all illustrative of such prior art. While these units may be suitable for the particular purpose to which they address, they would not be as suitable for the purposes of the present invention as heretofore described.

U.S. Pat. No. 2,245,133

Inventor: Thomas Hopkins; Issued: Jun. 10, 1941; The invention relates to metal bars for reinforcing concrete, and has for its principle object the provisions of a linear scale whereby uniform divisions of the entire length of the bar are visually indicated in feet, inches and fractions of an inch.

U.S. Pat. No. 2,270,419

Inventor: Henry Debo; Issued: Jan. 20, 1942; This invention relates to wallboards having indicia for positioning the means of fastening the wallboards to a building frame or support.

U.S. Pat. No. 2,449,265

Inventor: Glenn Williams; Issued: Sep. 14, 1948; This invention relates to a conduit for use between an automobile engine system and a radiator and more particularly to conduit made of standard length and shape that may be cut to be fitted to a number of different automobiles according to a chart associated with the conduit.

U.S. Pat. No. 3,407,507

Inventor: Reginald Brubaker; Issued: Oct. 29, 1968; This invention relates generally to measuring instruments for measuring circumferential distances about a work member in a plane nonnal to its axis.

U.S. Pat. No. 4,149,320

Inventor: Daniel Troyer et al.; Issued: Apr. 17, 1979; Disclosed is a measuring tape and a method for its use that eliminates the necessity for manual measurement in the construction of buildings. The measuring tape comprises a pressure-sensitive adhesive tape having a minimum stretchability, which is adapted to be permanently secured onto a suitable base, and which has imprinted thereon at least one numerical scale and a plurality of a spaced series of coded indicia for use as templates to position particular structural members.

U.S. Pat. No. 4,351,113

Inventor: Claire Eggertsen et al.; Issued: Sep. 28, 1982; A pressure sensitive adhesively backed disposable measuring tape which has desirable properties that increase its utility. The tape has a combination of tensile strength, adhesion strength, elasticity and markability which make it desirable for use in common measuring applications. The tape is manufactured by passing a creped paper adhesively backed tape over a printing drum which has a rubber matte around its periphery. The rubber matte is embossed with a set of false indicia so that as a result of the normal method of mounting on the outer surface of the drum the outer surface of the matte indicates and prints a correct set of indicia on a creped paper tape.

U.S. Pat. No. 4,858,402

Inventor: Helmar Putz; Issued: Aug. 22, 1989; In order to facilitate the placing of gypsum plasterboards, the boards are provided on their surface with a marking, which comprises length scales extending along regularly spaced apart lines which are parallel to the edges of the board. The marking may preferably be applied in the form of paints which fade under the action of light.

U.S. Pat. No. 4,927,696

Inventor: Louis Berg; Issued: May 22, 1990; Material for use in fabrication having reference markings spaced uniformly such that the markings can be used for measurement.

U.S. Pat. No. 5,632,095

Inventor: James Day; Issued: May 27, 1997; A lumber product for use in the cutting and assembling of lumber for the framing of a building, having a first and second end, and a face and back surface and opposite edges; and a plurality of visible markings lines stamped or imprinted on at least one surface of the lumber piece, extending generally the length of the lumber and placed at selected intervals for framework measuring, cutting or assembly.

U.S. Pat. No. 5,673,489

Inventor: Glenn Robell; Issued: Oct. 7, 1997; A means of girded measurement for the cuing of construction materials which comprises the imprinting of commonly used measurement markings upon the surfaces of construction materials during the manufacturing process to save time and improve the accuracy of cutting the construction materials on a job site. Unit markings may be numbered for quick dimensional reference and fractional markings may also be used. The lines for commonly used markings may also be highlighted, darkened, doubled, tripled, dashed or dotted, and color enhanced for easy recognition. Applications may include, but are not limited to, use on wallboard, shower board, insulation, gypsum board, plywood, and any other material which must be cut to exact measurements on a construction job site. Angled cuts may be easily made by cutting along the opposite corners of a predetermined number of grids counted in both horizontal and vertical directions.

U.S. Pat. No. 5,924,213

Inventor: Baek Woo Lee; Issued: Jul. 20, 1999; The numerical measurement indicia is placed along the width and length of a sheet of material like plywood or drywall to aid in cutting and nailing to the frame. The linear construction material also contains numerical measurement indicia in a lengthwise direction to assist in cutting and affixing to other structures.

U.S. Pat. No. 6,269,595

Inventor: David Blubaugh et at.; Issued: Aug. 7, 2001; A wallboard or drywall system with two types of measuring indicia on one side of the wall board or drywall, and on integral, transparent vapor barrier is applied to the back side of the wallboard or drywall. In addition, the system contains adhesive coated plastic tape which can be used to seal adjacent, mating edges of wallboard or drywall panels.

### SUMMARY OF THE PRESENT INVENTION

The present invention relates generally to measuring markings and, more specifically, to a method of providing a measurement system, marked upon various types of products that require a specified cut in length. For example, the material to be measured can be any extrusion or roll formed product to which a measuring device in accordance with the present invention is applied such as siding (aluminum, steel or vinyl), trim accessories used in conjunction with the siding, pipe lengths (plastic, PVC, steel or the like) or similar devices.

A primary object of the present invention is to provide a method and system for measuring various types of products that require a specified cut in length which will overcome the shortcoming of prior art measuring systems.

Another object of the present invention is to provide a method and system for measuring extrusion or roll formed products for application to materials such as siding (aluminum, steel or vinyl), and trim accessories used in conjunction with the siding. Yet another object of the present invention is to provide a method of and system for measuring, for application to materials products such as pipe lengths (plastic, PVC, steel or the like) or similar devices.

Another object of the present invention is to provide a method and system for measuring, including units of measurement marked on a material extending along an edge of the material from one distal end toward the second distal end and alternate units of measurement extending along an opposing edge of the material from the second distal end toward the first.

An even further object of the present invention is to provide a method and system for measuring wherein the units of measurement can be any suitable units such as inches, feet, centimeters, yards, meters and a combination thereof.

Additional objects of the present invention will appear as the description proceeds. The present invention overcomes the shortcomings of the prior art by providing a method and system for measuring various types of products that are required to be cut to a specified length. For example, the material to be measured can be any extrusion or roll formed product intended to be cut to fit a job site per applications such as siding (aluminum, steel or vinyl), trim accessories used in conjunction with the siding, pipe lengths (plastic, PVC, steel or the like) or similar products. The measuring system of the present invention is applied to the surface of the product to be measured. The measurement system includes a unit of measurement extending along an edge of the measuring material from one distal end toward the second distal end and a unit of measurement extending along an opposite edge from the second distal end toward the first. The units of measurement can be any suitable units such as inches, feet, centimeters, yards, meters and a combination thereof The measuring material may be applied by any of; stamping with hot, cold or thermal press, roll press, notching, tabs, label/decal, pneumatic, laser, printing or etching.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWING FIGURES

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of a user using the measurement system of the present invention at a job site;

FIG. 2 is an enlarged perspective view of the measurement system of the present invention taken in the direction of an arrow labeled with the reference numeral 2 in FIG. 1;

FIG. 3 is a front view of the measuring system of the present invention attached to a piece of siding by the manufacturer thereof so that upon completion of the final product the measuring system will be concealed from sight;

FIG. 4 is a perspective view of the measuring system of the present invention attached to piping;

FIG. 5 is a perspective view of the measuring system of the present invention attached to a roll of pliable material;

FIG. 6 is a perspective view of the measuring system of the present invention attached to a gutter;

FIG. 7 is an illustrative view of a user illuminating material including the measurement system of the present invention printed upon the material in invisible ink;

FIG. 8 is a block diagram indicating alternative methods for application of the measuring system of the present invention; and

FIG. 9 is a perspective view of an alternative embodiment of the measuring system of the present invention.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to those skilled in the art to practice the invention, and it is to be understood that other embodiments may be utilized and that structural changes may be made without departing from the scope of the invention. In the accompanying drawings, like reference characters designate the same or similar parts throughout the several views.

### DESCRIPTION OF THE REFERENCED NUMERALS

Turning now descriptively to the drawings, in which similar reference characters denote similar elements throughout the several views, the Figures illustrate the method of providing a measurement markings of the present invention. With regard to the reference numerals used, the following numbering is used throughout the various drawing figures.

10—method of providing a measuring system of the present invention; 12—worker; 14—siding; 15—overlap line of the siding; 16—writing utensil; 17—hole; 18—piping; 20—roll of pliable material; 22—gutter; 24—wall paper; 26—black light; 28—tape; 30—perforation; 32—adhesive layer; 34—peel off layer.

### DETAILED DESCRIPTION OF THE PREFERRED EMBODIMENT

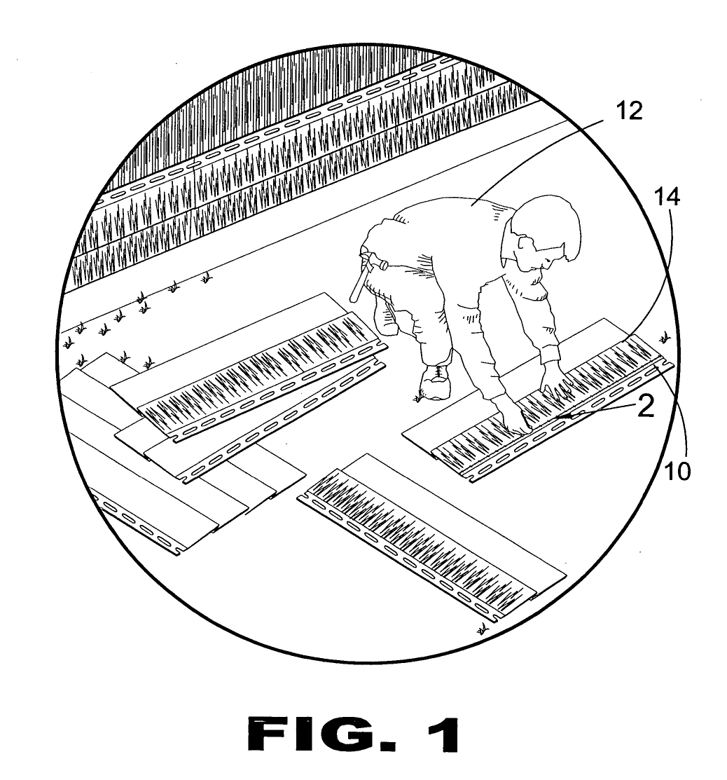

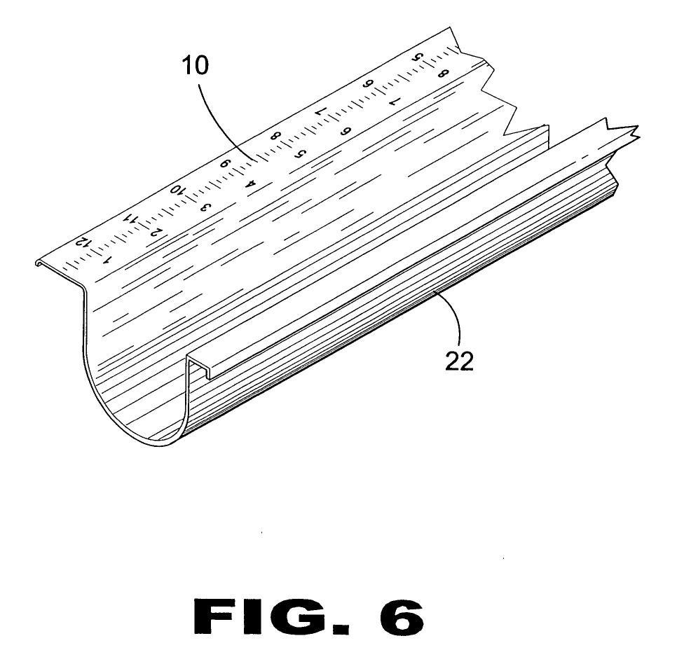

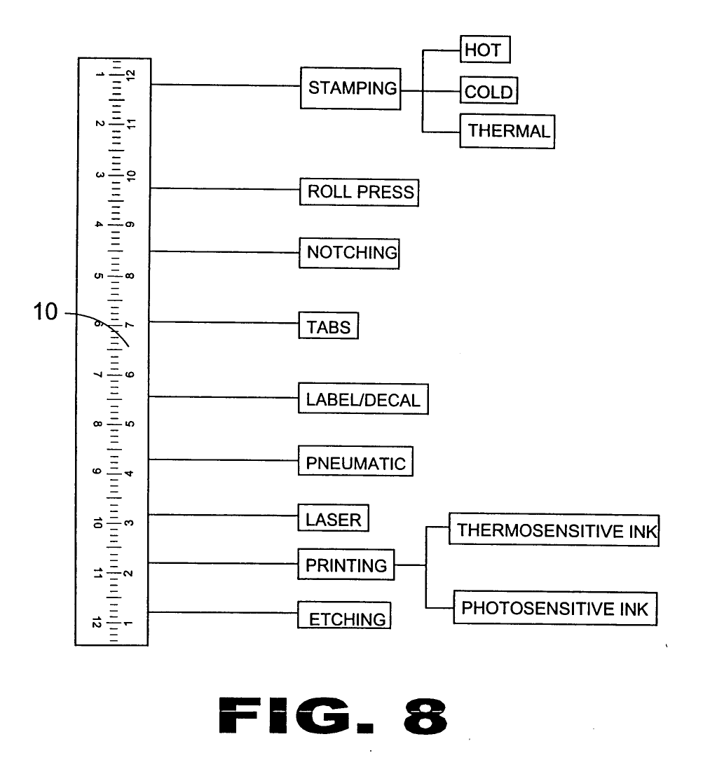

Turning now descriptively to the drawings, in which similar reference characters denote similar elements throughout the several views, FIGS. 1 through 9 illustrate the measurement system of the present invention indicated generally by the numeral 10.

FIG. 1 is a perspective view of a worker 12 using the measurement system 10 of the present invention at a job site. The measurement system 10 includes predetermined markings indicating a length and is attached to various types of products that are required to be cut to a specified length. When the measuring system is attached to a product, a worker 12 is able to manipulate the product to determine precisely and quickly the proper orientation and size required for the particular job being performed by making measurements with the markings placed on the particular product by the measurement system 10 of the present invention. For example, the material used can be any extrusion or roll formed product intended to be cut to fit a job site per applications such as siding 14 (aluminum, steel or vinyl), trim accessories used in conjunction with the siding 14, pipe lengths (plastic, PVC, steel or the like) or similar devices. The measuring system 10 of the present invention is attached to the surface of the product in a format conspicuous to a worker at a job site. The measurement system 10 may be attached during fabrication of the particular material to be measured or positioned on a fabricated product by a worker 12 for a quick assessment of a required length of material to be used. The measurement system 10 includes a first unit of measurement extending along an edge thereof from one distal end toward the second distal end and a second unit of measurement extending along an edge of the system opposite the first unit forms the second distal end toward the first. The first and second units of measurement can be any suitable units such as inches, feet, centimeters, yards, meters or any combination thereof Use of such a measuring system 10 allows for precise measurements to be made quickly in addition to providing a clear indication of the length of a given material so as not to confuse closely sized items.

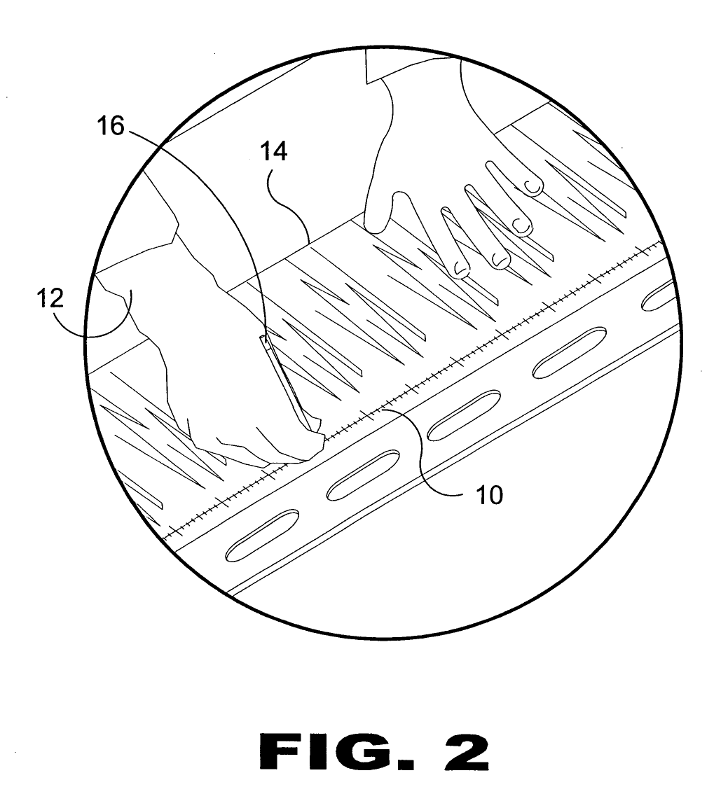

FIG. 2 is an enlarged perspective view taken in the direction of the arrow labeled with the of reference numeral 2 in FIG. 1 of a user measuring a piece of siding 14 with the measurement system 10 of the present invention. The area marked with the measurement system 10 is capable of being scored with a writing instrument 16. Thus, the worker 12 may selectively adjust the size of the material or determine locations for securing the material in place by insertion of a securing device in accordance with markings made by the worker 12 on the measuring system 10. The measurement system 10 allows the worker 12 to make precise measurements without the use of additional tools such as a tape measure or a ruler. The measuring system 10 may be positioned on the surface of the siding 14 (aluminum, steel, or vinyl) by a worker 12 at a job site or may be attached to a product upon manufacture. The measurement system 10 includes a first unit of measurement extending along one edge thereof from one distal end toward the second distal end and a second unit of measurement extending along an opposite edge from the first units thereof from the second distal end toward the first end. The first and second units of measurement can be any suitable units such as but not limited to inches, feet, centimeters, yards, meters and a combination thereof including fraction or decimal portions thereof.

Measurement markings 10 may include visual indicators such as lines drawn at predetermined distances corresponding to a selected unit of measurement or bumps, symbols, or holes placed in a similar fashion along the length and/or with of a product. As shown in FIG. 2, the measurement system embodies lines placed at predetermined intervals along the longitudinal axis of a piece of aluminum siding. The worker 12 is shown marking the siding with a writing instrument 16 at a desired point using the measurement system 10. The worker 12 is able to use these markings to adjust the size or secure the siding in place with tacks or the like.

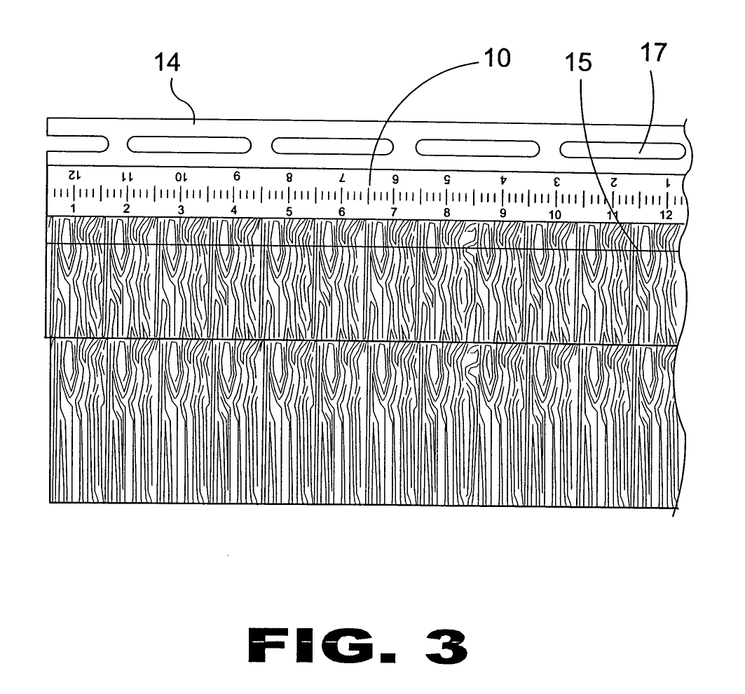

FIG. 3 is a perspective view of the measuring system 10 of the present invention attached along an edge of a piece of siding 14 by the manufacturer. Application of the measurement system 10 in this position allows for the measuring system 10 to be concealed from sight upon completion of the final product. By producing the siding 14 with the measurement system 10 thereon, the siding 14 may be selectively cut, bent, creased, or alternatively manipulated at determined locations corresponding to indicia on the measurement system 10. Shown is a measurement system 10 placed along an edge of the surface of siding 14 between holes 17 used for attaching the siding and a line 15 indicative of the point at which a subsequent piece of siding will overlap. Such placement ensures the concealment of the measurement system 10 beneath an adjacent piece of siding, thus preventing the measurement system 10 from being visible upon completion of the finished product. The measuring system 10 of the present invention is applied to the surface of the siding 14 in a format that is easily understandable by a worker 12 at a job site. The measurement system 10 includes markings corresponding to a first unit of measurement extending along an edge thereof from one distal end toward the second distal end and markings corresponding to a second unit of measurement extending along an opposing edge from the second distal end toward the first. The first and second units of measurement can be any suitable units such as but not limited to inches, feet, centimeters, yards, meters and a combination thereof.

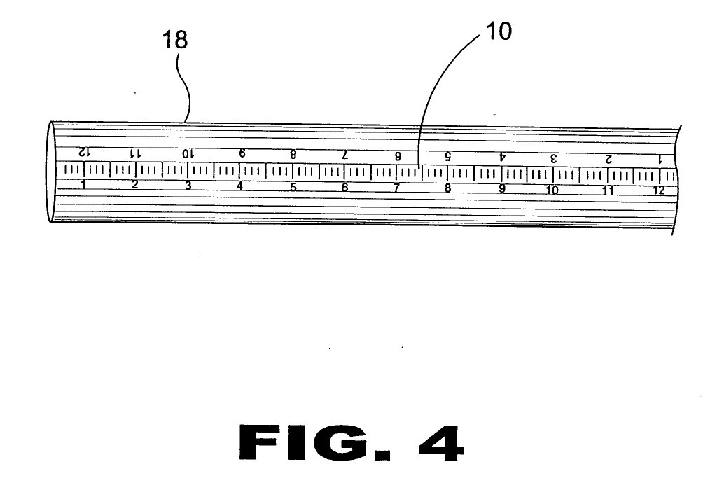

FIG. 4 is a perspective view of the measuring system 10 of the present invention attached to piping 18. The measuring system may be attached by the manufacturer upon production or positioned thereon by a user prior to use. The measuring system 10 is applied to the surface of a pipe 18 in a format easily readable by a worker at a job site. The measurement system 10 includes markings indicative of a linear scale extending along a length of the pipe 18 from one end towards an opposing end thereof and a second set of markings representing a linear scale extending along the length of the pipe in an opposite direction. The first and second linear scales may correlate with any suitable units unit of measurement such as, but not limited to inches, feet, centimeters, yards, meters and any combination thereof.

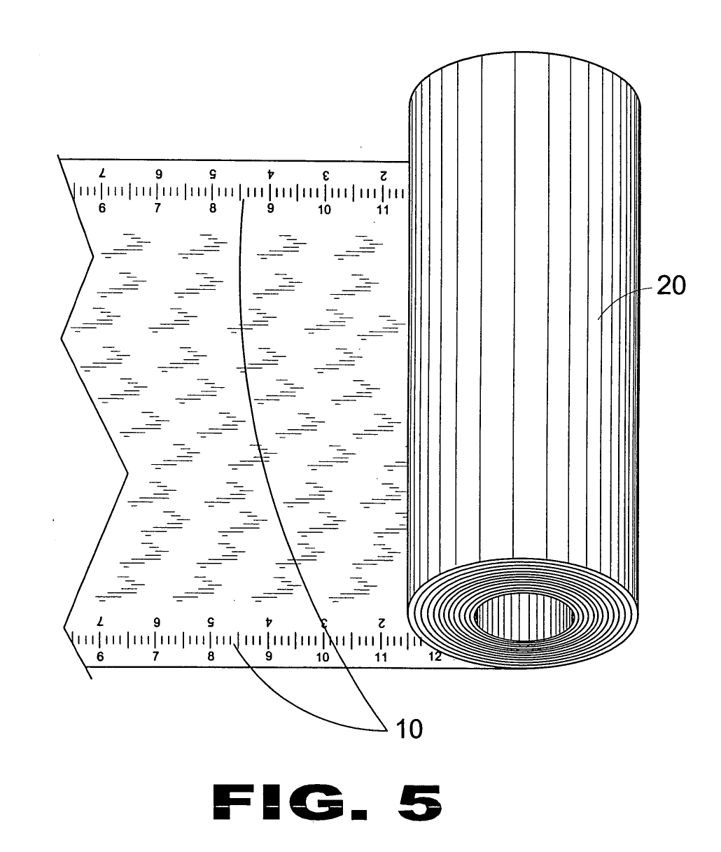

FIG. 5 is a view of the measuring system 10 applied to a roll of pliable material 20 representative measurements thereof The measurement system 10 may be temporarily applied to a product as a label/decal if a weak adhesive is used on the measuring system. Thus, the measurement markings are removable after the desired measurements are made. Alternatively, the measuring system may be attached to the desired material with a strong adhesive. Thus able to withstand extreme conditions and remain on the product it is affixed to. The indicia may be roll pressed, laser printed, etched, or stamped onto the desired material. Both a flexible material and/or a rigid material may be used for positioning the indicia. The indicia are provided in various colors for achieving optimal visibility dependant on the color of the background material. Additionally, the markings may be provided in a color which is most discrete when contrasted to the background color of the material. Such examples are photosensitive chemicals, which are only visible when illuminated by a black light, or thermal sensitive chemicals that provide visible color of markings when exposed to a predetermined temperature. In addition to ink type markings, the markings may be of indiscrete notches, grooves, or bumps only apparent to the touch or an extremely close look.

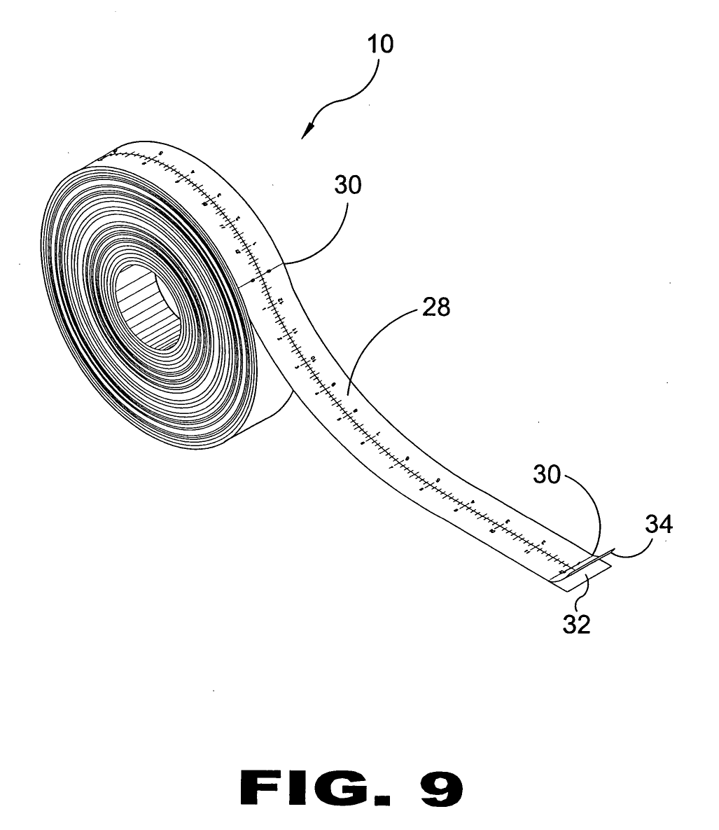

FIG. 9 is a perspective view of an alternative embodiment of the measuring system 10 of the present invention. Illustrated is a perspective view of the measuring system 10 of the present invention applied to a roll of tape 28. The measurement system 10 is printed on one side of the tape and an adhesive covers the opposite side. A peel off layer 32 covers the adhesive side 34. When attached, the peel off layer 32 allows for easy alignment of the measurement tape 28 in a desired position. Removing the peel off layer 32 exposes the adhesive on the adhesive side 34 of the tape 28. Perforations 30 may be applied to the tape at predetermined intervals for easy detachment of a section of tape 28 from the entire role. The selected section of adhesive tape 28 is positioned upon the object to be measured with the adhesive side 34 facing the object to be measured.

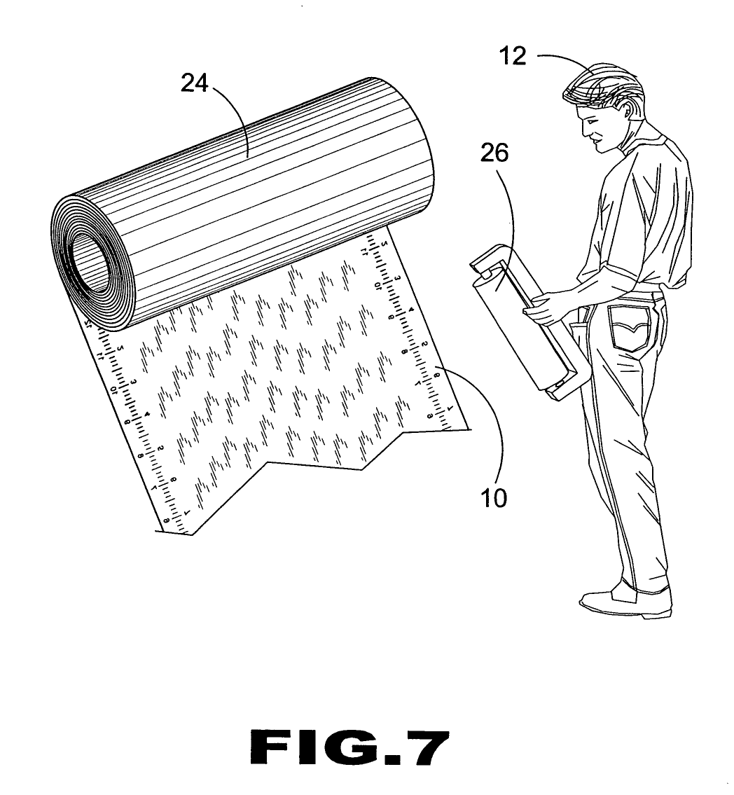

The tape 28 may be printed in a solid color for contrasting the color of the markings representative of a linear scale thereon. Additionally, the tape 28 may be transparent for indiscreetly blending with an object to which it is applied. The markings of the linear scale of the measurement system 10 may be made in photosensitive ink as described in FIG. 7 or alternatively as thermosensitive ink which is apparent only when placed at a predetermined temperature.

In operation, the measurement system may be attached to a product in a permanent fashion by use of a strong adhesive. The indicia may be positioned thereon by stamping, pressing, printing, etching, or notching the markings of a linear scale to the surface of the measurement system by a manufacturer thereof. Additionally, a worker through the use of an adhesive tape can position the measurement system on the surface of a product.

Alternatively, the manufacturer may place the markings of the measurement system in a conspicuous location on the product for easy observance by a worker upon production. The linear scale may be of any denomination suitable to the size of the product and the precision to which it is customarily manipulated. The markings for the measurement system may by in a color which contrasts with the color of the applied product when products such as piping or sheetrock, which are often concealed by paint or enclosures, are used.

In circumstances that the finished product will not be concealed by further operations to the product by a consumer or worker, the markings may be applied with photosensitive ink that is only visible to the eye when illuminated with a black light. Additionally, the use of thermosensitive ink, which is visible when put at a desired temperature, may be used to produce the markings. Thermosensitive ink may be made visible by rubbing an area in which the ink is used, the heat caused by the friction of the rubbing causes the ink to become visible and contrast with its background until cooling. Another example of benefits conferred from thermosensitive ink is for monitoring products known to expand and contract due to heat fluctuations. Further, a weak adhesive may be used for application in conspicuous areas so that the measurement system may be easily removed once the required measurement is made.

Providing the measuring system as an adhesive tape allows for a worker to make quick measurements of products to which the measurement system of the present invention is not attached during the manufacturing process. The measurement system is printed on one side of the tape and an adhesive covers an opposite side thereof A peel off layer covers the adhesive side. When attached, the peel off layer allows for easy alignment of the measurement tape in a desired position. Removing the peel off layer exposes the adhesive on the adhesive side of the tape. Perforations are applied to the tape at predetermined intervals for easy detachment of a section of tape from the entire role. The selected section of adhesive tape is positioned upon the object to be measured with the adhesive side facing the object to be measured.

The tape may be printed in a solid color for contrasting the color of the markings representative of a linear scale thereon. Additionally, the tape may be transparent for indiscreetly blending with an object to which it is applied. The markings of the linear scale of the measurement system may be made in photosensitive ink as described in FIG. 7 or alternatively as thermo sensitive ink which is apparent only when placed at a predetermined temperature.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. Siding having an integrated measuring system that can be concealed from sight upon completion of a project, the siding comprising:
an exterior surface;
a first distal end;
a second distal end; and
a first measuring indicia printed on the exterior surface by a printing process during fabrication of the siding, the first indicia extending from the first distal end to the second distal end and dividing the siding into measuring units, wherein a user can measure and cut the siding material without using a separate measuring device.

2. The siding of claim 1, wherein the first measuring indicia is configured to be hidden under a portion of a second piece of siding.

3. The siding of claim 1, further comprising a second measuring indicia extending from the second distal end to the first distal end and dividing the siding into measuring units.

4. The siding of claim 3, wherein the second measuring indicia is configured to be hidden under a portion of a second piece of siding.

5. The siding of claim 1, wherein the printing process is selected from the group consisting of stamping, roll pressing, notching, tabbing, decaling, laser printing and etching.

6. The siding of claim 1, wherein the first indicia is printed in a photosensitive ink, said photosensitive ink being visible when illuminated by a black light.

7. The siding of claim 1, wherein the first indicia is printed in a thermosensitive ink, said thermosensitive ink being visible when heated to a predetermined temperature.

8. The siding of claim 1, further comprising a plurality of apertures, wherein the first indicia are adjacent to the plurality of apertures.

9. A construction material with integrated measuring system, the construction material comprising:
a exterior surface; and
a measuring indicia printed on the exterior surface by a printing process as said construction material is processed, the measuring indicia dividing the construction material into measuring units, wherein a user can measure and cut the construction material without using a separate measuring device.

10. The construction material as recited in claim 9, wherein the exterior surface is selected from the group consisting of piping, wallpaper, sheetrock, decking and siding.

11. The construction material as recited in claim 10, wherein the printing process is selected from the group consisting of stamping, roll pressing, notching, tabbing, decaling, laser printing and etching.

12. Siding having an integrated measuring system comprising:
a surface;
a first measuring indicia disposed on the surface during fabrication of the siding, the measuring indicia dividing the siding into measuring units, wherein a user can measure and cut the siding material without using a separate measuring device.

13. The siding of claim 12, further comprising:
a first distal end, and;
a second distal end;
wherein the first measuring indicia extends from the first distal end to the second distal end.

14. The siding of claim 13, further comprising a plurality of apertures for attaching the siding to a structure, wherein the first measuring indicia is positioned adjacent to the apertures.

15. The siding of claim 14, wherein the first measuring indicia is configured to be hidden under at least a portion of a second piece of siding upon installation of the second piece of siding.

16. The siding of claim 15, further comprising a second measuring indicia distinct from the first measuring indicia.

17. The siding of claim 16, wherein the second measuring indicia extends from the second distal end to the first distal end.

18. The siding of claim 17, wherein the second measuring indicia is configured to be hidden under at least a portion of a second piece of siding upon installation of the second piece of siding.

19. The siding of claim 18, wherein the first indicia is printed in a photosensitive ink, said photosensitive ink being visible when illuminated by a black light.

20. The siding of claim 18, wherein the first indicia is printed in a thermosensitive ink, said thermosensitive ink being visible when heated to a predetermined temperature.
